(19) United States
(12) Patent Application Publication
(10) Pub. No.: US 2018/0220641 A1
(43) Pub. Date: Aug. 9, 2018

(54) DEVICE FOR PROXIMAL TARGETING OF ANIMALS

(71) Applicant: ECOLOGICAL HORIZONS PTY LTD, Kimba, South Australia (AU)

(72) Inventor: John L. Read, Kimba, South Australia (AU)

(21) Appl. No.: 15/749,079

(22) PCT Filed: Aug. 3, 2016
(86) PCT No.: PCT/AU2016/050701

§ 371 Date: Jan. 30, 2018

(30) Foreign Application Priority Data
Aug. 5, 2015 (AU) PCT/AU2015/000465

(51) Int. Cl. A01M 31/00; A01M 25/00

(52) U.S. Cl. CPC A01M 31/002; A01M 25/00

(57) ABSTRACT

An animal targeting system includes a set of activation sensors, a set of deactivation sensors and a pharmaceutical delivery mechanism. A first activation sensor can detect a presence of a target animal at a first position. A second activation sensor can detect the presence of the target animal at a second position. A first deactivation sensor can detect a lack of presence of the target animal at a threshold height higher than an expected height of the target animal. A second deactivation sensor can detect a presence of a gap between an abdomen of the target animal and ground level. The pharmaceutical delivery mechanism ejects a pharmaceutical onto a coat of the target animal based on the detected presence of the target animal by the activation sensors and based on the lack of detection of characteristics inconsistent with the target animal by the deactivation sensors.

### CROSS-REFERENCE TO RELATED APPLICATION(S)

This application claims priority to and the benefit of International Application No. PCT/AU2015/000465, filed on Aug. 5, 2015, the contents are which are hereby incorporated by reference in their entirety.

### BACKGROUND

### Technical Field

The disclosure generally relates to the field of an animal targeting system, and more particularly to a system that detects an animal within a proximity of the system, determines if the detected animal is a target animal, and ejects a pharmaceutical substance onto a coat of the target animal for subsequent ingestion by the target animal, for instance during grooming (“targeting system” or “targeting device” hereinafter).

### Description of the Related Art

Felis catus (the domestic cat, “Felis catus” or “felis catus” hereinafter) have been domesticated as human companions for thousands of years. This domestication has led to high populations of Felis catus throughout the world. With this unnaturally large global population of Felis catus, a significant number have become wild and feral, living without reliance on humans and creating feral offspring, thereby increasing the global population further.

Feral Felis catus and other predators are responsible for the death of a large number of small to medium-sized native animals such as mammals, birds, reptiles, amphibians, fish and insects, which can contribute to the native animals being threatened or even becoming extinct. Accordingly, in many ecologically-sensitive environments, feral Felis catus have become an invasive species, damaging habitat and threatening native species.

Historically, many methods of feral Felis catus control have been attempted. Various types of traps have been used, but the cautious nature and intelligence of Felis catus have made such traps an ineffective measure for mass control. Baits have been used, but the preference of feral felis catus for live meals has limited the effectiveness of baits outside of times of food scarcity. Hunting has been attempted, but the generally nocturnal feeding activity of feral felis catus and the high cost and labor intensive nature of hunting prevent it from having a substantial impact on feral felis catus populations.

### SUMMARY

A targeting system is used to detect an animal within a proximity of the system, determine if the detected animal is a target animal, and eject a pharmaceutical substance onto a coat of the target animal for subsequent ingestion by the target animal, for instance during grooming (“targeting system” or “targeting device” hereinafter).

For example, the targeting system includes one or more activation sensors, one or more deactivation sensors, a pharmaceutical delivery mechanism, and a controller. The one or more activation sensors are configured to detect the presence of a target animal based on characteristics of the target animal. The one or more deactivation sensors are configured to detect characteristics of an animal that are inconsistent with the target animal. The controller is configured to determine if a detected animal is a target animal based on a combination of the activation sensor data received from the activation sensors and the deactivation sensor data received from the deactivation sensors. In response to determining that a detected animal is a target animal, the controller instructs the pharmaceutical delivery mechanism to eject a pharmaceutical onto a coat of the target animal, where it will be ingested during grooming habits of the target animal.

Use of proximity targeting is particularly effective in targeting animals for pharmaceutical delivery that are wary of or averse to entering enclosed spaces, such as those required by walk-in, walk-through, or walk-under traps. In typical embodiments, the targeting system is non-enclosing, non-constraining, and does not entrap the target animal. Use of non-penetrating proximity targeting, i.e., delivering the pharmaceutical to the coat of the target animal, improves specificity: specificity is achieved first by discriminant delivery of the pharmaceutical substances to target versus non-target animals, coupled with a second level of discrimination that relies on behaviors, notably grooming behaviors, that further discriminate between target animals having strong grooming instincts from non-target animals that do not.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 illustrates a block diagram of a targeting system for targeting an animal, according to one embodiment.

FIG. 2A illustrates an example of a targeting system identifying a target animal, according to one embodiment.

FIG. 2B illustrates an example of a targeting system identifying a non-target animal, according to one embodiment.

FIG. 2C illustrates an example of a targeting system identifying a non-target animal, according to one embodiment.

FIG. 3 is an exemplary flowchart illustrating a process for ejecting a pharmaceutical onto a coat of an identified target animal, according to one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Targeting System Configuration

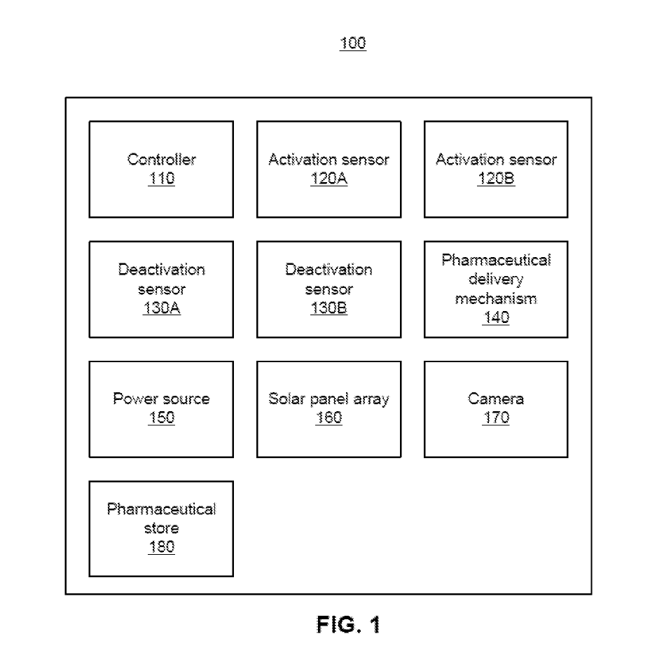

FIG. 1 illustrates a high-level block diagram of a targeting system for targeting an animal, according to one embodiment. The targeting system 100 of the embodiment of FIG. 1 includes a controller 110, an activation sensor 120A and an activation sensor 120B (collectively, “activation sensors 120”), a deactivation sensor 130A and a deactivation sensor 130B (collectively, “deactivation sensors 130”), a pharmaceutical delivery mechanism 140, a power source 150, a solar panel array 160, a camera 170, and a pharmaceutical store 180. In some embodiments, the targeting system 100 includes fewer or additional components than those described herein (for instance, the targeting system 100 can include multiple cameras, and may not include a camera 170).

The activation sensors 120 are configured to detect the presence of a target animal (for instance, in front of or within a line of sight of the targeting system 100), and to generate activation sensor data corresponding to the detection of the presence of the target animal. The target animal is defined as an animal that is targeted by the targeting system 100. Example target animals include a Felis catus, a Vulpes vulpes, a Mustelidae, a mongoose, or any other feral animal or invasive animal species. In some embodiments, the activation sensors 120 can also detect various characteristics of the target animal's physical appearance and/or behavior, such as the size of the target animal (e.g., height, length, width), walking patterns of the target animal, movement patterns of the target animal, and textures, colors, or visual patterns of the target animal's outer surface (e.g., fur, skin, hide, or feathers). One or more activation sensors 120 are used to detect the presence of the target animal, and are at least partially exposed on an outer surface of the targeting system 100. The activation sensors 120 can be spaced laterally apart within the targeting system 100, for instance by about ⅔ to ¾ the length of the target animal.

In some embodiments, the activation sensors 120 include a first activation sensor 120A and a second activation sensor 120B. The first activation sensor 120A is configured to detect a presence of the target animal at a first position relative to the targeting system 100. For example, the first activation sensor 120A detects the front of the target animal (such as the shoulder or head of the target animal). The second activation sensor 120B is configured to detect the presence of the target animal at a second position relative to the targeting system 100. For example, the second activation sensor 120B detects the rear of the target animal (such as the rump of the target animal). In some embodiments, the activation sensors 120 are configured to detect a presence of a target animal at positions more than a lateral threshold distance apart, thereby enabling the targeting system 100 to detect the target animal (expected to be longer than the lateral threshold distance) while disregarding non-target animals that are shorter in length than the lateral threshold distance.

In response to detecting the presence of a target animal, each activation sensor 120 sends sensor data or a signal indicative of the detected presence of the target animal to the controller 110. In some embodiments, more than one activation sensor 120 can be implemented within the trap 100 to detect the presence of a target animal at the first position, and more than one activation sensor can be implemented within the targeting 100 to detect the presence of a target animal at the second position. In some embodiments, any number of activation sensors can be included within the targeting system 100, each configured to detect a presence of an animal, for instance at varying positions or heights, or various characteristics of the animal. These activation sensors can include a variety of different types, including visual recognition and beam intercept sensors, optical or infrared sensors, acoustic sensors, and the like, working together or in isolation. By detecting the target animal at different positions relative to the targeting system 100, the activation sensors 120 can beneficially detect the target animal walking from left to the right relative to the targeting system, or walking right to left relative to the targeting system.

It should be noted that in some embodiments, each of the activation sensors 120 is configured to detect the target animal at a different height. For instance, the activation sensor 120A can detect the target animal at a first height above ground level (for instance, at a head level of the target animal), and the activation sensor 120B can detect the target animal at a second height above ground level lower than the first height (for instance, at a rump level of the target animal). Such an embodiment beneficially enables the targeting system 100 to detect the target animal when the target animal moves directly towards the targeting system or directly away from the targeting system. In other embodiments, each of the activation sensors 120 detects the target animal at the same height above ground level.

The deactivation sensors 130 are configured to detect characteristics of an animal that are inconsistent with the target animal, and to generate deactivation sensor data corresponding to the detection of such characteristics inconsistent with the target animal. In some embodiments, a first deactivation sensor 130A is configured to detect the presence of an animal outside of the dimensions of the target animal. For example, the deactivation sensor 130A can detect the presence of an animal at a third height above ground level greater than the first height described above and corresponding to a height above the normal height of the target animal. The detection of an animal at such a height is indicative that the detected animal is not the target animal.

In some embodiments, a second deactivation sensor 130B is configured to detect a presence of an animal within an expected gap between an abdomen of the target animal and the ground level. For example, the second deactivation sensor 130B is positioned to detect the presence of an animal between ground level and a fourth height lower than the second height between the front legs and rear legs of the animal (e.g., sense the presence of the animal within what is otherwise an expected gap between the abdomen of the target animal, the ground level, and the front and rear legs of the target animal). The deactivation sensors 130, in response to the detection of characteristics of an animal inconsistent with the target animal, can send data or a signal indicative of the detected characteristics that are inconsistent with the target animal to the controller 110. In some embodiments, the targeting system 100 can include zero, one, or any number of deactivation sensors, each configured (either individually or in combination) to detect a characteristic of an animal inconsistent with a target animal.

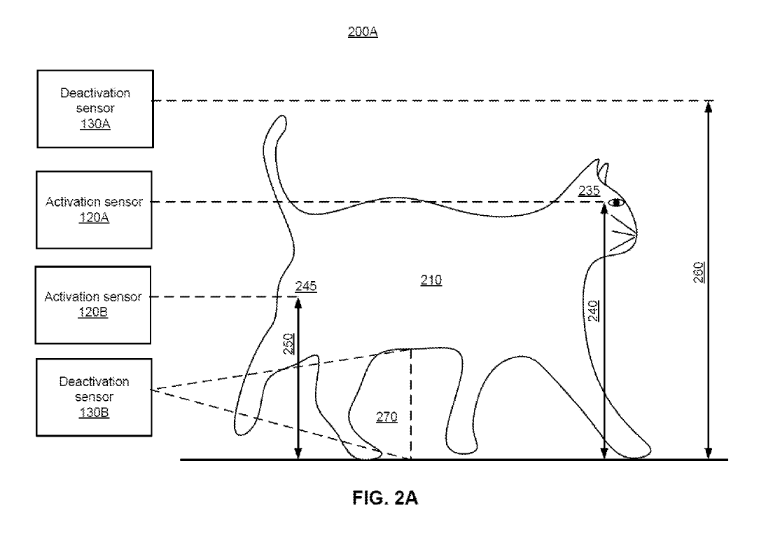

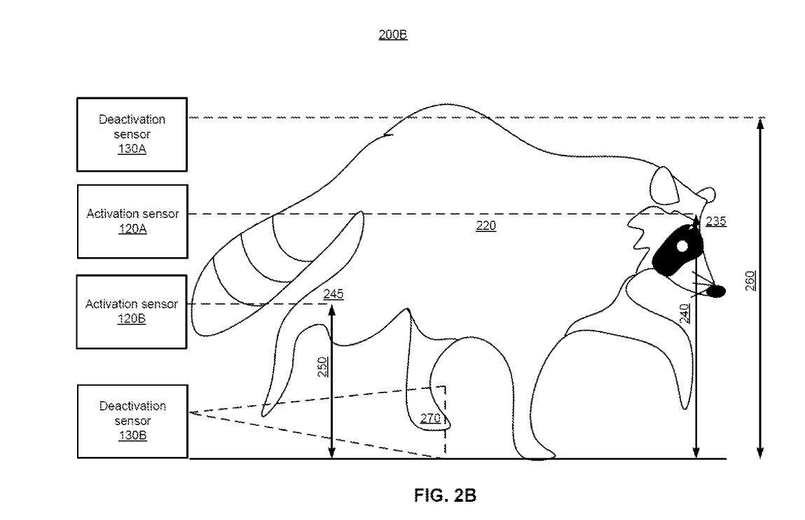

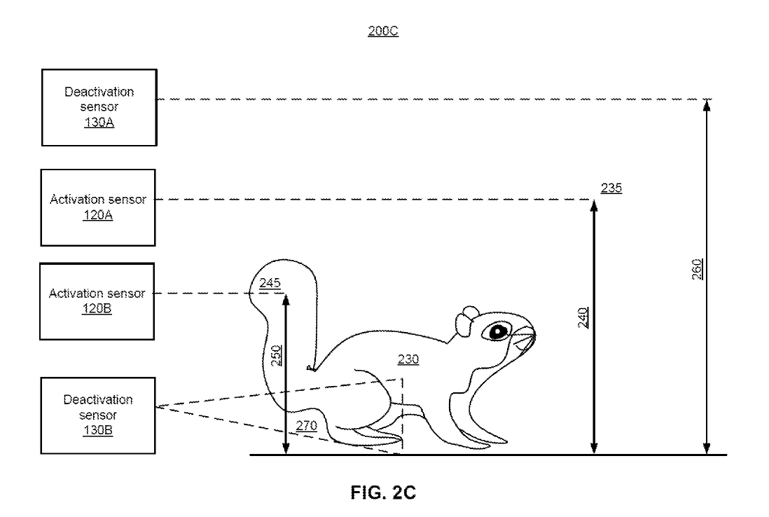

The controller 110 is configured to determine if a detected animal is a target animal based on a combination of the activation sensor data received from the activation sensors 120 and the deactivation sensor data received from the deactivation sensors 130. In response to determining that a detected animal is a target animal, the controller 110 instructs the pharmaceutical delivery mechanism 140 to eject a pharmaceutical onto a coat of the target animal. In some embodiments, the controller 110 instructs the camera 170 to capture an image of a detected animal. The controller 110 is further described below and with reference to FIGS. 2A-2C.

The camera 170 is configured to capture an image of animals or other moving objects detected by the targeting system 100 in response to an instruction by the controller 110. For instance, the camera 170 can, in response to determining that a detected animal is a target animal, capture an image of the detected target animal. Likewise, the camera 170 can capture an image of a detected animal determined not to be the target animal. By capturing images of both animals detected to be the target animal and otherwise, the camera 170 can enable a user of the targeting system 100 to audit the targeting system in order to determine the effectiveness and accuracy of the targeting system in detecting target animals, the accuracy of the activation sensors 120 in detecting animals generally, and the accuracy of the deactivation sensors 130 in identifying false positives among detected animals. Further, capturing images of detected animals allows a user to determine whether a pharmaceutical has been ejected onto a detected target animal (for instance, the camera 170 can capture an image after the pharmaceutical has been ejected), whether the ejected pharmaceutical missed the target animal, and the frequency of detected animals and objects determined to not be the target animal.

In some embodiments, the camera 170 can capture images both during the day and at night. For example, the camera 170 can be equipped with a flash or other light source to illuminate the target animal for capturing the image. The camera 170 may also have a night vision capability allowing the camera to operate in the infrared spectrum by using an invisible infrared flash or light source. In order to prevent startling a detected animal, the camera 170 can capture images of the detected animal without making a significant shutter sound, without activating a camera flash, and the like. In some embodiments, if one or more activation sensors, or one or more deactivation sensors are broken or are not proper functioning, the camera 170 can be used to perform the corresponding functions. In some embodiments, the camera 170 can capture images of a detected animal in real time, and one or more image classification or object recognition operations can be performed, for instance by the controller 110, to determine if a detected animal is a target animal, or to determine if a detected animal includes one or more characteristics inconsistent with the characteristics of the target animal.

The pharmaceutical delivery mechanism 140 is configured to, in response to an instruction from the controller 110, eject a pharmaceutical onto an external surface of a detected target animal. In some embodiments, the ejected pharmaceutical is a gel configured to, upon impacting a skin, fur, or hide of the target animal, at least partially adhere to the target animal. The target animal, upon grooming the outer surface of the target animal with a tongue of the target animal, will ingest the pharmaceutical, thereby subjecting the target animal to the physiological effects of the pharmaceutical. It should be noted that in some embodiments, the pharmaceutical delivery mechanism 140 is substantially silent when ejecting the pharmaceutical onto the target animal, beneficially reducing the likelihood that an ejection noise will startle the target animal before the pharmaceutical makes contact with the target animal.

In some embodiments, the pharmaceutical delivery mechanism 140 ejects the pharmaceutical towards and onto the target animal at a pre-determined angle. The predetermined angle is determined by several factors, such as the size of the target animal, behavior characteristics or patterns of the target animal, the distance between the targeting system 100 and the target animal, or some combination thereof. In some embodiments, the angle of ejection is fixed. In other embodiments, the angle of ejection can be varied by the controller 110 based on the distance of the target animal to the targeting system 100, characteristics of the target animal, or any other suitable factor. In order to ensure the ejected pharmaceutical makes contact with a target animal located at some distance from the targeting system 100, the pharmaceutical can be ejected directly outward and/or upward from the targeting system 100. For example, the pharmaceutical delivery mechanism 140 ejects the pharmaceutical at an angle between 0 degrees horizontally relative to the ground level and 45 degrees upward relative to the ground level. In one embodiment, the angle of ejection is controlled by the controller 110 based on sensor data, as further described below.

In some embodiments, the pharmaceutical delivery mechanism 140 ejects the pharmaceutical onto the target animal at a controlled speed within a threshold distance of the targeting system 100. The threshold distance can be a distance that represents a width of bush tracks along which a target animal walks, a distance over which the trajectory of the ejected pharmaceutical is unlikely to be affected by wind, or a distance over which the accuracy of the ejected pharmaceutical is determined or likely to be greater than a pre-determined accuracy threshold. The controlled speed at which the pharmaceutical is ejected can be fixed or variable, for instance determined based on factors including but not limited to the size of the target animal, the behavior of the target animal, the distance between the targeting system 100 and the target animal, or some combination thereof.

In one embodiment, to prevent the target animal from jumping out of a range of the ejection, the controlled speed of ejection is such that the time between ejection of the pharmaceutical and contact with the target animal is faster than a reflex time of the target animal. For example, the pharmaceutical delivery mechanism 140 can eject the pharmaceutical onto the target animal at a speed such that the pharmaceutical makes contact with the target animal within 50 milliseconds of ejection or of detecting the target animal. In another embodiment, the pharmaceutical delivery mechanism 140 ejects the pharmaceutical at the speed greater than a threshold speed (e.g., 30 meters per second) and selected based on a type of the target animal, a distance to the target animal, a trajectory of the target animal relative to the targeting system 100, and the like. In some embodiments, the controlled speed can be a fixed ejection velocity (e.g., as fast as 30 meters per second, 60 meters per second, or faster). In some embodiments, the speed of ejection of the pharmaceutical can be selected such that the trajectory of the pharmaceutical when ejected at a particular angle relative to the ground level can make contact with the target animal, even if the target animal is located up to 4 meters or more away from the targeting system 100. In some embodiments, the speed of ejection is selected such that the pharmaceutical can make contact with the target animal when ejected, but also such that the force of impact of the pharmaceutical onto the target animal does not cause the target animal any injury or pain.

In some embodiments, the pharmaceutical delivery mechanism 140 applies a pneumatic force to eject a pharmaceutical from a delivery nozzle of the pharmaceutical delivery mechanism (not shown in FIG. 1). In one embodiment, the pharmaceutical delivery mechanism 140 includes a pump that pumps the pharmaceutical through the delivery nozzle. In another embodiment, the pharmaceutical delivery mechanism 140 includes a container of compressed gas or air that, when applied to a vessel of the pharmaceutical delivery mechanism that includes the pharmaceutical, causes the pharmaceutical to be ejected through the nozzle, for instance through the opening of a valve (not shown) that opens in response to the detection of the target animal. In an alternative embodiment, the pharmaceutical delivery mechanism 140 ejects the pharmaceutical through the delivery nozzle using a compression spring or other energy source. In yet a further embodiment, the pharmaceutical delivery mechanism 140 includes a vessel fit with a plunger configured to eject the pharmaceutical housed within the vessel. In yet a further embodiment, the pharmaceutical delivery mechanism 140 includes one or more actuators configured to apply an electric, hydraulic, combustible/explosive, or other force to the pharmaceutical or an ejection mechanism of the pharmaceutical delivery mechanism, causing the pharmaceutical to be ejected from the targeting system 100.

In some embodiments, the pharmaceutical delivery mechanism 140 is configured to eject the pharmaceutical onto a portion of an exterior of the target animal amenable to grooming by the target animal. For instance, the pharmaceutical can be ejected onto a front chest area of the target animal, a limb of the target animal, an abdominal region of the target animal, a side of the target animal, a back of the target animal, or a rump of the target animal. Although the description herein focuses on embodiments requiring an animal to groom to ingest the pharmaceutical, in other embodiments, the pharmaceutical can be absorbed through the animal's coat and skin. The pharmaceutical delivery mechanism 140 can aim at a particular portion of the exterior of the target animal using a tracking mechanism, for instance by analyzing images of the target animal captured by the camera 170, by selecting the portion of the exterior of the target animal at which the pharmaceutical is to be ejected upon, and by selecting a position, trajectory, and speed at which to eject the pharmaceutical such that the pharmaceutical makes contact with and adheres to the portion of the exterior of the target animal.

The pharmaceutical store 180 stores pharmaceutical for the target animal. In some embodiments, the pharmaceutical is designed to euthanize the target animal, e.g., a fatally toxic pharmaceutical. For example, if the target animal is an Australian feral felis catus, the pharmaceutical can be sodium fluoroacetate 1080 (“1080”). 1080 is present in a number of Australian native flora species, which has led to many species of Australian native animals having a higher tolerance to 1080 than introduced species such as feral felis catus. Thus, a predetermined dose of 1080 can euthanize the feral felis catus without harming other Australian native species. Example pharmaceuticals can also include para-aminopropiophenone (“PAPP”), sodium nitrite, cyanide, or other suitable toxins. In some embodiments, instead of being toxic, the pharmaceutical can be beneficial to the target animal. For example, the pharmaceutical can include a medicine intended to inoculate the target animal, such as an oral vaccine, treat a known or possible medical condition of the target animal, or provide other benefits to the target animal. In some embodiments, the pharmaceutical is intended to mark the target animal. For example, the pharmaceutical can include a dye or marking agent for tracking purposes.

The power source 150 is configured to store power and to provide the stored power to components of the targeting system 100. In some embodiments, the power source 150 provides power to all or some of the activation sensors 120, the deactivation sensors 130, the pharmaceutical delivery mechanism 140, the controller 110, and the camera 170. In some embodiments, the power source 150 is a power storage device, such as a battery or capacitor bank. In some embodiments, the controller 110 monitors the power level remaining in the power source 150. In response to the determination that the power level falls below a threshold, the controller 110 can disable certain functions of the targeting system (such as the capturing of images by the camera 170, the disabling of audio signals intended to attract the target animal, and the like).

The solar panel array 160 is configured to convert light incident upon the solar panel array into electrical power, and to store the electrical power in the power source 150. For instance, the solar panel array 160 converts sunshine during daytime into power in order to recharge the power source 150. In some embodiments, the solar panel array 160 is located on an outer or top surface of the targeting system 100. In some embodiments, the solar panel array is embedded within the power source 150. In other embodiments the solar panel array 160 is positioned remote from the targeting system. It should be noted that in some embodiments, the power source 150 can be recharged by a generator or an external power source, can be a replaceable power source (e.g., a replaceable battery that is swapped out periodically), or can be itself located remotely from the targeting system 100 (for instance, via power lines electrically coupling the power source 150 to the targeting system).

### Example Pharmaceutical Store

In some embodiments, the pharmaceutical store 180 stores several doses of the pharmaceutical. This allows multiple target animals to be targeted with the pharmaceutical before the targeting system 100 needs to be refilled. In embodiments in which the pharmaceutical is a toxin, the dosage of toxin supplied in the pharmaceutical is at least sufficient to incapacitate the target animal, and may cause death instantaneously or delayed relative to the ejection of the pharmaceutical, for instance via toxin-induced anoxia or other physiological effect. In some embodiments, the pharmaceutical is 1080 and the dosage of 1080 is between 10 mg and 15 mg, which may illustratively be supplied as 0.4 ml of 30 g/L concentrate 1080. In some embodiments, the pharmaceutical is PAPP and the dosage of the pharmaceutical is between 100 mg and 300 mg. In other embodiments, the toxin supplied in the pharmaceutical is delivered within a volume of fluid between approximately 1 and 5 ml.

To increase the chances of the pharmaceutical adhering to the coat of the target animal, the pharmaceutical may be supplied in a viscous form. In one embodiment, the pharmaceutical includes a gel formulation. In some embodiments, the gel formulation has a consistent viscosity at a range of temperatures and pressures, and can beneficially improve the reliability of the speed, direction, and precision of the ejection of the pharmaceutical. In other embodiments, the pharmaceutical includes a grease formulation, or is administered as a spray. In some embodiments, a syringe or similar vessel is adapted (e.g., as part of the targeting system 100) to provide separate measured doses of the pharmaceutical for each ejection of the pharmaceutical by the targeting system. In some other embodiments, a larger vessel (e.g., a canister or tank) provides a constant supply of the pharmaceutical to be applied or ejected in amounts corresponding to single doses per application/ejection. In some embodiments, different target animals may receive different doses of the pharmaceutical. The dose of the pharmaceutical applied to a given target animal can be selected by the controller 110, for instance based on the type of the target animal detected by a combination of the activation sensors and deactivation sensors.

In some embodiments, the pharmaceutical is enclosed within a frangible membrane designed to rupture upon contact with the target animal. The frangible membrane contains the pharmaceutical and each membrane, which may be in the form of a capsule, pellet, ball, or the like, contains a distinct unit dose of the pharmaceutical. In such embodiments, the pharmaceutical delivery mechanism 140 can shoot or eject the frangible membrane at the target animal, which ruptures upon contact with the target animal, causing the pharmaceutical enclosed within to contact and/or stick to the coat of the animal. In some embodiments, the frangible membrane is shot at the target animal at a speed fast enough to ensure the frangible membrane ruptures, but at a speed slow enough to prevent significant pain from being caused to the target animal.

### Example Activation/Deactivation Sensors

In some embodiments, one or more of the activation sensors 120 and deactivation sensors 130 are configured to measure and record a distance to a detected animal within the vicinity of the targeting system 100. Determining a distance to a detected animal enables the camera 170 to be able to properly focus and/or adjust the intensity of a camera flash to capture quality images of the detected animal at different distances (for instance, in response to an instruction from the controller 110). For example, based on the measured distance, the intensity of the flash can be adjusted automatically to prevent overexposure of close animals and underexposure of distant animals. Determining a distance to a detected animal also enables multiple detected objects at different distances to be distinguished from a target animal at one distance from the targeting system, and enables the targeting system 100 to be able to determine if the activation sensors 120 each detect an object at a same distance, or detect different objects at different distances. Further, determining a distance to a detected animal enables the targeting system 100 to determine if a detected animal is more than a maximum threshold distance away, thereby enabling the targeting system to prevent the pharmaceutical from being ejected onto the detected animal (for instance, if the threshold distance represents a further distance at which the ejected pharmaceutical is likely to contact the animal). Finally, determining a distance to a detected object enables the targeting system 100 to determine if a detected object is closer to the targeting system than a minimum threshold distance, thereby enabling the targeting system to disqualify the detected object from consideration as the target animal (for instance, the detected object can be dust, condensation, or other matter that, when very close to the targeting system can trigger one or more of the sensors of the targeting system).

In embodiments in which the activation sensors 120 and/or deactivation sensors 130 are able to determine a distance to a detected animal, the sensors can include optical or ultrasonic rangefinders. In some embodiments, a sensor can include an array of four infrared rangefinder sensors. Each infrared rangefinder sensor can transmit pulses of a narrow beam of infrared light. Reflections from objects in the path of the beam are detected by a receiver coaxial with the transmitter or immediately adjacent to the transmitter. The time of flight of the reflected beam is determined by the sensor, which computes the distance of the object from the targeting system 100 based on the determined time of flight of the reflected beam.

In some embodiments, the activation sensors 120 or deactivation sensors 130 include one or more light transmitters and one more light receivers. The light transmitter transmits light to the light receiver. In some embodiments, an animal can pass between the light transmitters and light receivers, and break the transmitted light beam between some or all of the transmitter-receiver pairs. The light receivers detect the broken light beams and indicate the presence of an animal to the controller 110. In some embodiments, the transmitted light beams are focused light, such as laser beams.

In some embodiments, the activation sensors 120 or the deactivation sensors 130 can include one or more sensors each, or can include arrays or sets of sensors. The activation sensors 120 or deactivation sensors 130 can be optical sensors (for instance, sensors that operate outside of the visible spectrum of the target animal so as to not be visible to the target animal), ultrasonic sensors (for instance, sensors that operate at sound frequency outside of the hearing range of a target animal so as to not scare aware the target animal), or any other suitable sensor configured to detect the presence of an object.

In some embodiments, each of the set of activation sensors 120 and deactivation sensors 130 can include multiple sensors arranged to capture a large field of view (e.g., 180 degrees in front of the targeting system 100 or 360 degrees around the targeting system 100). In some embodiments, the field of views of two adjacent sensors overlap, thereby increasing the total field of view of the sensors. In some embodiments, the sensors can rotate, enabling animals to be detected within a 360 degree field of view around the targeting system 100. In some embodiments, the sensors rotate and detect an animal from a series of different angles in a coarse manner (e.g., low resolution, sparse dataset). The sensors can then send the sensor data associated with the detection of the animal to the controller 110, which in turn can position the sensors at an angle determined by the controller to best determine if the detected animal is a target animal in a fine manner (e.g. high resolution, dense data).

In some embodiments, the activation sensors 120 and the deactivation sensors 130 can be trained to recognize and ignore new landscape elements in the field of view of the sensor (e.g., vegetation that grows around the targeting system 100 or objects blown or deposited into the field of view of the sensors). For example, the targeting system 100 can be left in a particular location for a period of time, and the sensors can detect the movements, weight, or heat of the objects in the surrounding environment. When the sensors subsequently detect movement within the vicinity of the targeting system 100, the controller 110 can determine if the movement corresponds to previously detected movement of objects within the surrounding environment of the targeting system 100 (and thus disregard the detected movement), or is caused by a new object within the vicinity of the targeting system (for instance, in response to a determination that the detected movement is not consistent with the previously detected movement).

In one embodiment, one or more of the activation sensors 120 or the deactivation sensors 130 include a video camera (e.g., a CCD camera) that records still and/or video images of animals or other objects. In such embodiments, the sensors capture images of an animal to distinguish target animals from non-target animals (for instance, with real time optical recognition software stored in the controller 110). In some embodiments, the sensors capture images of an animal and determine if the characteristics of the animal (for instance, the height, length, coloring of the animal) are consistent with the target animal. It should be noted that in some embodiments, the cameras can perform any of the functionality of the activation sensors 120 or the deactivation sensors 130 described herein.

In some embodiments, the position of the activation sensors 120 and the deactivation sensors 130 can be adjusted, for instance by the controller 110, according to the size of the target, the behavior or movement of the target animal, the distance of a detected animal from the targeting system 110, or based on any other suitable factor.

### Ejecting a Pharmaceutical Onto a Coat of an Identified Target Animal

The controller 110 is configured to determine if a detected animal is a target animal based on a combination of the activation sensor data received from the activation sensors 120 and the deactivation sensor data received from the deactivation sensors 130. In response to determining that a detected animal is a target animal, the controller 110 instructs the pharmaceutical delivery mechanism 140 to eject a pharmaceutical onto a coat of the target animal. In some embodiments, the controller 110 can also instruct the camera 170 to capture an image of a detected animal in response to either determining that the detected animal is the target animal and/or determining that the detected animal is not the target animal.

In some embodiments, the controller 110 determines if a detected animal is a target animal in response to the combination of 1) the detection of the presence of the target animal by a first activation sensor (such as the activation sensor 120A) at a first position (such as a front of a target animal), 2) the detection of the presence of the target animal by a second activation sensor (such as the activation sensor 120B) at a second position (such as a rear of the target animal), 3) the detection of the lack of presence of the target animal by a first deactivation sensor (such as the deactivation sensor 130A) at a third position (such as a height greater than an expected height of the target animal), and 4) the detection of the presence of the gap between the abdomen of the target animal and ground level by a second deactivation sensor (such as the deactivation sensor 130B).

In some embodiments, the controller 110 can categorize different detected animals and can distinguish the target animal from multiple smaller objects which have similar dimensions to those of the target animal. For example, the controller 110 can determine the distance of the detected objects, and can adjust the positions and heights at which the activation sensors 120 and deactivation sensors detect the target animal based on the distance of the detected objects. Likewise, the controller 110, in response to determining that a detected object is associated with multiple distances from the targeting system 100, can determine that the detected object is actually many detected objects (for instance, a pack/flock/swarm of animals smaller than the target animal), and can determine that the detected object is thus not the target animal. In some embodiments, the controller 110 can determine that a detected object is moving too fast to be the target animal (for instance, the detected object can break an activation sensor beam for an interval of time much shorter than a target animal would break the beam, indicating that the detected object is too fast to be the target animal).

In some embodiments, the controller 110 determines if a detected animal is a target animal based on the image captured by the camera 170. For example, the controller 110 can analyze images of a detected animal in real time, can compare the images to a set of reference images or known target animal characteristics (such as visual features of the target animal or behavior patterns associated with the target animal), and can identify the animal as the target animal (or can determine that the animal is not the target animal) based on the comparison. In some embodiments, the controller 110 identifies a detected animal as the target animal based on a combination of an output of one or more activation sensors 120, an output of one or more deactivation sensors 130, and an analysis of images captured by the camera 170.

In some embodiments, the controller 110 instructs the pharmaceutical delivery mechanism 140 to eject the pharmaceutical onto the coat of the detected target animal. For example, the controller 110 determines an ejection angle and an ejection speed based on factors including but not limited to the size of the target animal, the behavior of the target animal (such as the speed the target animal can move), the distance between the targeting system 100 and the target animal, or some combination thereof.

As noted above, the controller 110 can instruct the camera 170 to capture an image of a detected animal or object. For example, the controller 110 can instruct the camera 170 to capture a still and/or video image and can store the captured image in a memory. The memory may at a later time be queried by a user to see what objects were observed by the camera 170 (e.g., for auditing purposes). The controller 110 may store additional information associated with each image, such as the time and date of acquisition, whether it each image was determined to include a target animal, whether a pharmaceutical was ejected onto the animal, and the like. This recorded data can be used to evaluate the effectiveness of the tray system 100 and refine algorithms implemented by the controller 110.

FIG. 2A illustrates an example of a targeting system identifying a target animal 210, according to one embodiment. As shown in FIG. 2A, the target animal 210 is a feral felis catus 210. The controller 110 adjusts the activation sensors and deactivation sensors based on characteristic of the feral felis catus 210 (e.g., size, walking, movement). The first activation sensor 120A is positioned to detect the felis catus 210 at position 235 and a height 240 corresponding to a shoulder or head of the feral felis catus. The second activation sensor 120B is positioned to detect the feral felis catus 210 at a position 245 and a height 250 corresponding to a rump of the feral felis catus. The first deactivation sensor 130A is positioned to detect objects at a height 260 higher than the height 240, and higher than the height range of the feral felis catus. The second deactivation sensor 130B is positioned to detect a gap between the abdomen (at a fourth height above ground level lower than the height 250) of the feral felis catus 210 and the ground level. Although depicted as different heights, as noted above, in some embodiments the heights 240 and 250 are the same height, such that the activation sensor 120A and the activation sensor 120B detect the target animal at a same height above ground level. It should also be noted that although the beam emitted by the deactivation sensor 130B is divergent/conical, in other embodiments, the beam comprises a narrow that that detects the presence of any gap between the abdominal region of a target animal and ground level (as opposed to detecting the presence of a gap of a particular height).

If the first and second activation sensors are triggered (e.g., each activation sensor detects the target animal at the respective first and second positions), the first deactivation sensor is triggered (e.g., the deactivation sensor 130A does not detect the target animal at the third height), and the second deactivation sensor is triggered (e.g., the deactivation sensor 130B detects the gap between the abdomen of the feral felis catus 210 and the ground level), the controller 110 identifies the detected animal as the target animal. The controller 110 can instruct the camera 170 to capture images of the detected animal for further processing, for instance verification of the classification of the detected animal, categorization of the target animal based on the image characteristics to reduce subsequent classification time, or other research. In response to identifying the animal as the target animal, the controller 110 instructs pharmaceutical delivery mechanism 140 to eject the pharmaceutical onto the target animal (for instance, at an angle and speed determined by the controller based on the size and distance of the target animal).

FIG. 2B illustrates an example of a targeting system identifying a non-target animal, according to one embodiment. An animal 220 (e.g., a raccoon, dog, wolf, and the like) larger than the target animal 210 walks into the working area of the targeting system. The first deactivation sensor 130A is triggered by the animal (e.g., the deactivation sensor 130A detects the animal 220 at the height 260). The controller 110 then identifies the detected animal 220 as a non-target animal and blocks pharmaceutical delivery mechanism 140. The controller can also instruct the camera 170 to capture images of the animal 220 for verification and subsequent processing. FIG. 2C illustrates another example of a targeting system identifying a non-target animal, according to one embodiment. An animal 230 (e.g., a squirrel) smaller than the target animal 210 walks into the working area of the targeting system. The first activation sensor 120A is not triggered (in response to not detecting the animal 230 at the first position 235), and the second deactivation sensor 130B is not triggered (in response to not detecting a gap between the abdomen of the animal 230 and the ground). The controller 110 identifies the detected animal 230 as a non-target animal, and blocks the pharmaceutical delivery mechanism 140 from ejecting the pharmaceutical. The controller can also instruct the camera 170 to capture images of the animal 230 for verification and subsequent processing.

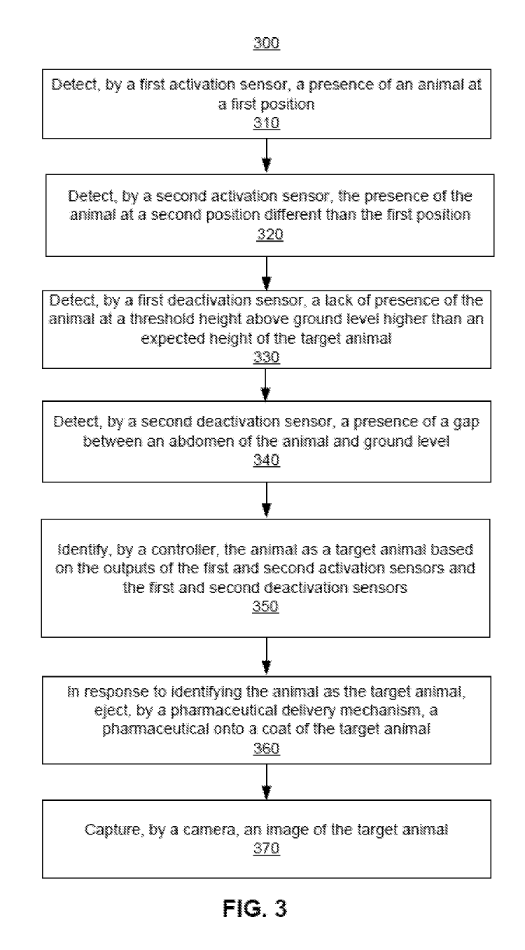

FIG. 3 is an exemplary flowchart illustrating a process 300 for ejecting a pharmaceutical onto a coat of an identified target animal, according to one embodiment. The process 300 may include different or additional steps than those described in conjunction with FIG. 3 in some embodiments, or may perform steps in different orders than the order illustrated in FIG. 3.

The first activation sensor 120A detects 310 a presence of an animal at a first position. The second activation sensor 120B detects 320 the presence of the animal at a second position. The first deactivation sensor 130A detects 330 a lack of presence of the animal at a threshold height above ground level higher than an expected height of the target animal. The second deactivation sensor 130B detects 340 a presence of a gap between an abdomen of the animal and the ground level. The controller 110 identifies 350 the animal as a target animal based on the outputs of the first and second activation sensors 120 and the first and second deactivation sensors 130. For instance, the controller 110 can identified the animal as a target animal in response to 1) the first activation sensor 120A and the second activation sensor 120B detecting the animal at the first and second positions, respectively, 2) the lack of a detection of the animal at the threshold height by the deactivation sensor 130A, and 3) the detection of the gap between the abdomen of the animal and the ground by the deactivation sensor 130B.

The pharmaceutical delivery mechanism 140 ejects 360 a pharmaceutical onto a coat of the target animal in response to identifying the animal as the target animal. The camera 170 captures 370 an image of the target animal. It should be noted that in some embodiments, the controller 110 can identify the animal as the target animal in response to other combinations of outputs by the activation sensors 120 and the deactivation sensors 130. For instance, in some embodiments, the controller 110 can require the detection of the animal by just one of the activation sensors 120A and 120B to identify the animal as the target animal. Likewise, the controller 110 can identify the animal as the target animal in response to either the lack of detection of the target animal by the deactivation sensor 130A or the detection of the gap between the abdomen of the animal and the gap.

In some embodiments, if one or more activation sensors detect an object, and a deactivation sensor detects a characteristic of the detected object inconsistent with a characteristic of the target animal, the deactivation sensor can disable the targeting system 100 for an interval of time (e.g., 10 minutes), during which the targeting system does not detect objects (and as a result, does not eject a pharmaceutical). Disabling the targeting system 100 in response to detecting an object that isn't the target animal is not likely to cause the target system to miss detecting the target animal, as the target animal is unlikely to be found near (for example) larger animals. Further, in embodiments where a larger animal is detected by a deactivation sensor (thereby preventing the pharmaceutical from being ejected) and subsequently crouches down and/or otherwise prevents the deactivation sensor from detecting the larger animal, disabling the targeting system 100 for an interval of time (in response to the detection of the larger animal by the deactivation sensor) prevents the targeting system from inadvertently ejecting the pharmaceutical onto the larger animal.

As described herein, the targeting system 100 beneficially enables a pharmaceutical to be ejected onto the target animal without requiring the explicit trapping or constraining of the target animal. For instance, the targeting system 100 can identify a target animal and eject the pharmaceutical onto the target animal from a distance, as the target animal walks by or adjacent to the targeting system. In such embodiments, the target animal is not required to walk under or into the targeting system 100 in order to be sprayed with the pharmaceutical, and the targeting system does not enclose or prevent the target animal from moving or fleeing after the pharmaceutical is ejected onto the target animal.

In addition, as noted above, the pharmaceutical is configured to adhere to the target animal when ejected onto the target animal. This enables the pharmaceutical to be ingested by the target animal during the course of normal grooming. For instance, the target animal can instinctually attempt to “clean” the pharmaceutical off the coat of the target animal by grooming, thereby causing the pharmaceutical to be internalized by the target animal. If the pharmaceutical is accidentally ejected onto a non-targeted animal that does not groom, the non-targeted animal will not be affected by the pharmaceutical, which may be required to be ingested before taking effect. In some embodiments, the pharmaceutical is configured to adhere to the coat of the target animal for longer than a threshold amount of time, beneficially increasing the likelihood that the target animal ingests the pharmaceutical through grooming.

### Alternative Targeting System Configuration

In some embodiments, the targeting system 100 can also include a lure, a telemetry system, and a tag reader to assist with the attraction, identification, logging, and targeting of target animals or the exclusion of non-target animals.

A lure can include at least one transmitter to project the lure to attract a target animal. In one embodiment, the lure is an audio lure and the transmitters are speakers to transmit sounds attractive to the target animal. The audio lure can emit a recorded sound of prey of the target animal in distress, the sound of a target animal in heat, or an alternative sound likely to attract the target animal. In another embodiment, the lure is a scent lure housing a scent source that is exuded from the lure through the transmitter via scent passageways. In an alternative embodiment, the lure is a visual lure, such as a light or moving object operated by transmitter.

A telemetry system is configured to transmit data through a telemetry antenna to a remote user or data collection center with data such as sensor images/signals, a time and date of detected animals, captured images of detected animals, and the like. The telemetry system can include a wireless receiver, transmitter, or transceiver hardware. The telemetry system may also transmit other status data, such as an energy level of the power source 150 (e.g. state of battery charge), an amount of toxin or pharmaceutical remaining in the delivery mechanism 140, diagnostic codes in the event of a malfunction, and the like. Data may also be transmitted to the targeting system 100 via the telemetry system, such as updated algorithms for the controller 110 to detect target animals, firmware updates, and the like.

In some areas where target animals are present, there is a risk that non-targeted domesticated animals will interact with the targeting system 100. Some domesticated animals are tagged with an RFID chip or other electronic tagging, such as some domesticated felis catus. Alternatively, the domesticated animal may be equipped with a collar holding an RFID tag or a visual identifier. A tag reader detects the presence of a tag, a collar, or other indicia and can classify an animal detected by the activation sensors 120 or the camera 170 corresponding to the detected tag as not a target animal, causing the ejection of the pharmaceutical by the pharmaceutical delivery mechanism 140 to be blocked.

In some embodiments, other blocking mechanisms, including RFID or other scanning technology and visual recognition software, can be incorporated into the target animal detection algorithm implemented by the controller 110 to further enable the controller 110 to distinguish target animals from non-target animals. Such blocking mechanisms can further distinguish between target feral cats and non-target pet cats (which may be fitted with identification devices or be otherwise distinguished by unique markings or apparel) and similar shaped non-target animals (such as quolls, which have patterns of white spots seldom found in cats).

### Additional Configuration Considerations

Throughout this specification, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An apparatus comprising:
a first activation sensor configured to detect a presence of a target animal within a proximity of the apparatus at a first position;
a second activation sensor configured to detect the presence of the target animal at a second position;
a first deactivation sensor configured to detect a lack of presence of the target animal at a threshold height above ground level;
a second deactivation sensor configured to detect a presence of a gap between an abdomen of the target animal and ground level;
a pharmaceutical delivery mechanism;
a controller configured to cause the pharmaceutical delivery mechanism to eject a pharmaceutical onto a coat of the target animal in response to 1) the detection of the presence of the target animal by the first activation sensor, 2) the detection of the presence of the target animal by the second activation sensor, 3) the detection of the lack of presence of the target animal by the first deactivation sensor, and 4) the detection of the presence of the gap between the abdomen of the target animal and ground level.

2. The apparatus of claim 1, wherein the pharmaceutical comprises a toxin, and wherein the pharmaceutical is configured to adhere to the coat of the target animal upon contact with the coat of the target animal.

3. The apparatus of claim 2, wherein the toxin comprises one or more of sodium fluoroacetate, para-aminopropiophenone, sodium nitrite, and cyanide.

4. The apparatus of claim 1, further comprising:
a power storage device configured to provide power to the first activation sensor, the second activation sensor, the first deactivation sensor, the second deactivation sensor, the pharmaceutical delivery mechanism, and the controller; and
a solar panel array configured to store power in the power storage device.

5. The apparatus of claim 1, further comprising:
a camera configured to capture an image of the target animal in response to the detection of the presence of the target animal by the first activation sensor or the second activation sensor.

6. The apparatus of claim 1, wherein the pharmaceutical delivery mechanism is configured to eject the pharmaceutical at an angle between 0 degrees horizontally relative to the ground level and 45 degrees upward relative to the ground level.

7. The apparatus of claim 1, wherein the first position comprises one or both of a threshold horizontal distance away from the second position and a threshold vertical distance away from the second position.

8. The apparatus of claim 1, wherein the first activation sensor and the second activation sensor are each configured to detect the presence of the target animal up to 10 meters away from the apparatus.

9. The apparatus of claim 1, wherein the pharmaceutical delivery mechanism is configured to eject the pharmaceutical at a speed greater than 30 meters per second.

10. The apparatus of claim 1, wherein a time interval between the detection of the target animal and the ejection of the pharmaceutical onto the coat of the target animal is less than 100 milliseconds.

11. An apparatus comprising:
a first set of one or more sensors configured to detect a presence of an animal within a proximity of the apparatus;
a second set of one or more sensors configured to detect one or more characteristics of the animal inconsistent with characteristics of a target animal;
a pharmaceutical delivery mechanism configured to eject a pharmaceutical onto the animal at an angle between 0 degrees outward and 45 degrees upward and outward relative to ground level; and
a controller configured to cause the pharmaceutical delivery mechanism to eject the pharmaceutical onto the animal in response to the detection of the animal by the first set of sensors and in response to the lack of detection of one or more characteristics of the animal inconsistent with characteristics of the target animal by the second set of sensors.

12. The apparatus of claim 11, wherein the pharmaceutical comprises a toxin lethal to the target animal.

13. The apparatus of claim 11, wherein the second set of one or more sensors is configured to detect a height of the animal greater than a threshold height.

14. The apparatus of claim 11, wherein the second set of one or more sensors is configured to detect a lack of a threshold distance between an abdomen of the animal and ground level.

15. The apparatus of claim 11, further comprising:
a battery configured to provide power to the first set of sensors, the second set of sensors, the pharmaceutical delivery mechanism, and the controller; and
a solar panel array configured to provide power to the battery for storage.

16. A method comprising:
detecting, by a first sensor of a targeting system, a presence of an animal within a proximity of the targeting system at a first position;
detecting, by a second sensor of the targeting system, a lack of a presence of the animal at a second position;
in response to detecting the presence of the animal at the first position and in response to detecting the lack of the presence of the animal at the second position, identifying, by a controller, the animal as a target animal; and
in response to identifying the animal as the target animal, ejecting, by a pharmaceutical delivery mechanism, a pharmaceutical onto a coat of the animal.

17. The method of claim 16, wherein the pharmaceutical comprises a toxin lethal to the target animal.

18. The method of claim 16, further comprising:
detecting, by a third sensor, a presence of an above-threshold distance between an abdomen of the animal and ground level;
wherein identifying the animal as the target animal is further in response to the detection of the presence of the above-threshold distance between the abdomen of the animal and ground level.

19. The method of claim 16, wherein the pharmaceutical delivery mechanism is configured to eject the pharmaceutical at an angle between 0 degrees outward and 45 degrees upward and outward relative to ground level.

20. The method of claim 16, further comprising:
capturing, by a camera, an image of the animal in response to detecting the presence of the animal by the first sensor or the second sensor.
